(19) United States
(12) Patent Application Publication
(10) Pub. No.: US 2012/0124150 A1
(43) Pub. Date: May 17, 2012

(54) INTELLIGENT NETWORK COMMUNICATION SYSTEM AND METHOD

(75) Inventors: Ying Ge, Nanjing (CN); Shu Tan, Nanjing (CN); Genying Xie, Nanjing (CN); Lin Xie, Nanjing (CN); Ming Kong, Nanjing (CN)

(73) Assignee: SAMSUNG ELECTRONICS CO., LTD., Suwon-si (KR)

(21) Appl. No.: 13/294,842

(22) Filed: Nov. 11, 2011

(30) Foreign Application Priority Data
Nov. 11, 2010 (CN) 201010546411.2
Nov. 9, 2011 (KR) 10-2011-0116662

(51) Int. Cl. G06F 15/16

(52) U.S. Cl. 709/206; 709/204

(57) ABSTRACT

A network communication system and method make communication and information sharing more convenient and efficient. The A system includes an account information management module and an account information storage module. The account information management module stores the friend accounts of the user and the corresponding account information. The account information storage module analyzes the account information of the friend accounts, and makes a determination according to the network account information contained in the account information such that the friend accounts belonging to the same friend are added to the same account group.

### CROSS-REFERENCE TO RELATED APPLICATION(S) AND CLAIM OF PRIORITY

The present application is related to and claims the benefit under 35 U.S.C. §119(a) of Chinese Patent Application filed on Nov. 11, 2010 and assigned Serial No. 201010546411.2 and Korean Patent Application filed on Nov. 9, 2011 and assigned Application No. 10-2011-0116662, the entire disclosures of which are hereby incorporated by reference.

### TECHNICAL FIELD OF THE INVENTION

The present invention relates to an intelligent network communication system and method, through which a user can browse the network activities of all the friends, recognize the online state of the friends, and choose the most proper way to communicate with the friends.

### BACKGROUND OF THE INVENTION

Along with the development of the network technology, communication through network becomes prosperous and is diverged into commonly used applications such as instant messaging (IM), multi-system instant messaging, SNS socializing website, Friend Feed, forums, online games, video and music website and so on.

Instant messaging (IM) normally indicates a system for performing instant communication on Internet, which allows two or more people to transmit character information, documents, voice and video communication instantaneously through the network. The IM is different from e-mail in that its communication is performed in real-time. Most IM services are capable of providing the state information, such as displaying the list of the contact person, the online state of the contact person, whether the connected people are available for talking. Popular IM services on the internet include IM services such as Windows Live Messenger, AOL Instant Messenger, Skype, Yahoo! Messenger, NET Messenger Service, Jabber, ICQ, QQ, to name a few. The IM software becomes popular because it is user friendly and allows the people to reach each other in real time with minimum cost, and becomes an important way to communicate with each other through Internet. By using the IM software, people can gain response from others in no time after sending messages, thus achieving an active interaction, which satisfies the requirement for synchronous communication.

As user desire keeps growing, the multi-system instant messaging service software such as eBuddy (www.ebuddy.com) began to emerge. The eBuddy is a network and cell phone application supporting multiple IM services, including MSN, YAHOO, AIM, GTALK, FACEBOOK, ICQ, MYSPACE and so on. The eBuddy is characterized in that: the user first logs in his/her eBuddy Web Message account, then registers his/her IM accounts. Then, the accounts of all the friends under the registered IM accounts are integrated into one window using different icons. Thus, the user may communicate with friends without switching the windows.

In addition, after logging in the social network service (SNS) websites (FACEBOOK, Happy Net, Renren network, etc.), the user can view the activity state of the friends in the social network.

FriendFeed is a personal information aggregation website, which can integrate the updating of the network community medium, social network service, bookmarker website, blog, microblog and other RSS/Atom information source. The user can collect this kind of information into Feed to share with friends or leave comments. Every user may need a personal friend feed account for the FriendFeed system, through which the user can view the trace of network activity of other friends on FriendFeed.

However, the conventional network communication have the following disadvantages:

(1) As for instant messaging service, the users using different instant messaging software cannot communicate with each other. In order to communicate with different friends, a user may need to register accounts of different instant messaging software. When a user makes contact with friends, he/she does not know which instant messaging service the friends are using. The user has to login different instant messaging accounts, which is rather inconvenient.

(2) As for the instant messaging integration service, although all the online states of the friends are integrated, the user may still need to login several accounts or websites and manually select a certain account of the friends to send out message.

(3) As for existing social network service (SNS), the user can only view the activity state of the friends within the respective networks. One user may have various social network accounts and the corresponding friend groups. When the user intends to check the state of the friends in different social networks, he/she may need to log in different networks, which is very inconvenient.

(4) As for FriendFeed system, a user may view the network activity track of friends of the FriendFeed. However, the user can only make network traces and communication in the friend groups of Friend Feed.

(5) As for the network activities such as forum, online games, online music, video and so on, the user still cannot learn all them in a single device.

Thus, it is necessary to develop a network communication system and method capable of integrating the accounts for instant messaging, the online state and the network traces of the friends.

### SUMMARY OF THE INVENTION

To address the above-discussed deficiencies of the prior art, it is a primary object to provide an intelligent network communication system and method.

According to an aspect of the present disclosure, there is provided a network communication system including an account information management module for storing the friend accounts of the user and the corresponding account information; and an account information storage module for analyzing the account information of the friend accounts, and makes determination according to the network account information contained in the account information of whether to add the friend accounts belonging to the same friend to the same account group.

The network communication system may further comprises an information receiving and transmitting management module and a state information management module, wherein, the information receiving and transmitting management module transmits and receives message between the network communication system and the network server the friend account belonging to; the state information management module manages the network activity trends information of the friend account, sends a request for inquiring the friend's activity trends to the network server and receives a response to the request from the network server so as to achieve the trend information inquiry of the friend.

The network communication system may further comprises a setting management module for providing a system account and code setting, an instant message account of the user is added under the system account.

When the user selects one friend for message transmission, the information receiving and transmitting management module may select a friend account of the friend for message transmission through one of first through third schemes. In the first scheme, when none of the friend accounts of the corresponding friend is online, the information receiving and transmitting management module requests the state information management module and sends an offline message to a friend account commonly used by the friend through analyzing the logging in history with respect to respective friend accounts of the corresponding friend; in the second scheme, when only one friend account is online with respect the friend, the information receiving and transmitting management module send a message directly to the friend account being online; and in the third scheme, when two or more friend accounts are online with respect to the friend, the information receiving and transmitting management module selects the friend account commonly used by the friend for message transmission according to the online state and the logging in history.

The account information storage module may perform an automatic grouping for the friend accounts through steps (a) through (d): step (a) is selecting one friend account among the friend accounts listed in all the network accounts own by the user, and extracting the account information of the selected friend account; step (b) is, if the account information of the selected friend account contains other network account, extracting the network account; step (c) is comparing the other network account with all the friend accounts stored in the account information storage module, to determine whether there is a network account identical to the network account; and step (d) is, if there is an identical network account, adding the selected friend account and the identical network account to the same account group.

If there is no other network account contained in the account information of the friend account in step (a), or if there is no network account identical to the other network account, the selected friend account is added to a new account group.

The state information management module may periodically transmit a trend inquiry request to the servers of respective friend accounts, and updates the network activity trend of the friend accounts.

The state information management module may update the online state and the logging in history of the friend account according to information received by the information receiving and transmitting management module.

The user may bind each of the account groups to a corresponding friend.

According to another aspect of the present disclosure, a network communication method is provided, comprising the steps of: (a) registering, by a user, a system account in a network communication system; (b) logging in the network communication system through the registered system account, and registers the respective instant messaging accounts owned under the system account; (c) the network communication system automatically adds all the friend accounts of the respective instant messaging accounts; and (d) grouping all the friend accounts according to an account information of the respective friend accounts.

Wherein, the step (d) may comprise (d1) selecting one friend account and extracting the account information of the friend account; (d2) determining whether the extracted account information contains other network account; (d3) if another network account is contained in the account information, comparing the another network account with each of all the friend accounts of each instant message account; (d4) if there is a friend account identical to the another network account, grouping the selected friend account and the identical network account into the same account group; and (d5) if there is no network account identical to the another network account, or if the account information does not contain other network account, adding the selected friend account to a new account group.

Wherein, the user may bind each of the account groups to a corresponding friend.

The network communication method may further comprises a friend trend updating step (e) of periodically transmitting a trend inquiry request to the servers of respective friend accounts, and updates the network activity trend and the logging in history of the friend accounts according to the received result of the trend inquiry.

The network communication method may further comprises a message transmission step (f) of, when message transmission to a certain friend is requested by the user, selecting one of the friend accounts owned by the friend for message transmission according to the online state and logging in history of the friend accounts of the friend.

Wherein the message transmission step may comprise transmitting the message through one of first through third schemes: the first scheme is, when none of the friend accounts of the corresponding friend is online, sending an offline message to a friend account most commonly used by the friend through analyzing the logging in history with respect to respective friend accounts of the corresponding friend; the second scheme is, when only one friend account is online with respect the friend, sending, by the information receiving and transmitting management module, a message directly to the friend account being online; and the third scheme is, when two or more friend accounts are online with respect to the friend, selecting, by the information receiving and transmitting management module, the friend account commonly used by the friend for message transmission according to the online state and the logging in history and transmitting the message.

Wherein, the friend trend updating step (e) comprises the steps of: (e1) selecting one friend; (e2) selecting one of the network accounts of the friend; (e3) sending a request for inquiring trend to the server which the network account belongs to; (e4) receiving a trend information, and updating the network activity trend of the network account; (e5) determining whether the trend inquiry has been made with respect to all the network accounts owned by the friend, and if the trend inquiry has been made, returning to step (e1) for selecting next friend, and unless the trend inquiry has been made, proceeding to step (e2) for selecting next network account.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a network communication system according to an exemplary embodiment of the present disclosure;

FIGS. 2 and 3 illustrate an account management of the network communication system according to an exemplary embodiment of the present disclosure;

FIG. 4 illustrates a process of a friend accounts intelligent management in the network communication system according to an exemplary embodiment of the present disclosure;

FIG. 5 illustrates a system verification method of the network communication system according to an exemplary embodiment of the present disclosure;

FIG. 6 illustrates a method for sending message in the network communication system according to an exemplary embodiment of the present disclosure;

FIG. 7 illustrating a method for achieving the message reception in the network communication system according to an exemplary embodiment of the present disclosure;

FIG. 8 illustrates a method for inquiring a friend information trend in the network communication system according to an exemplary embodiment of the present disclosure;

FIG. 9 illustrates a method for receiving a friend information trend in the network communication system according to an exemplary embodiment of the present disclosure; and

FIG. 10 illustrates an example for logging in the network communication system according to an exemplary embodiment of the present disclosure.

### DETAILED DESCRIPTION OF THE INVENTION

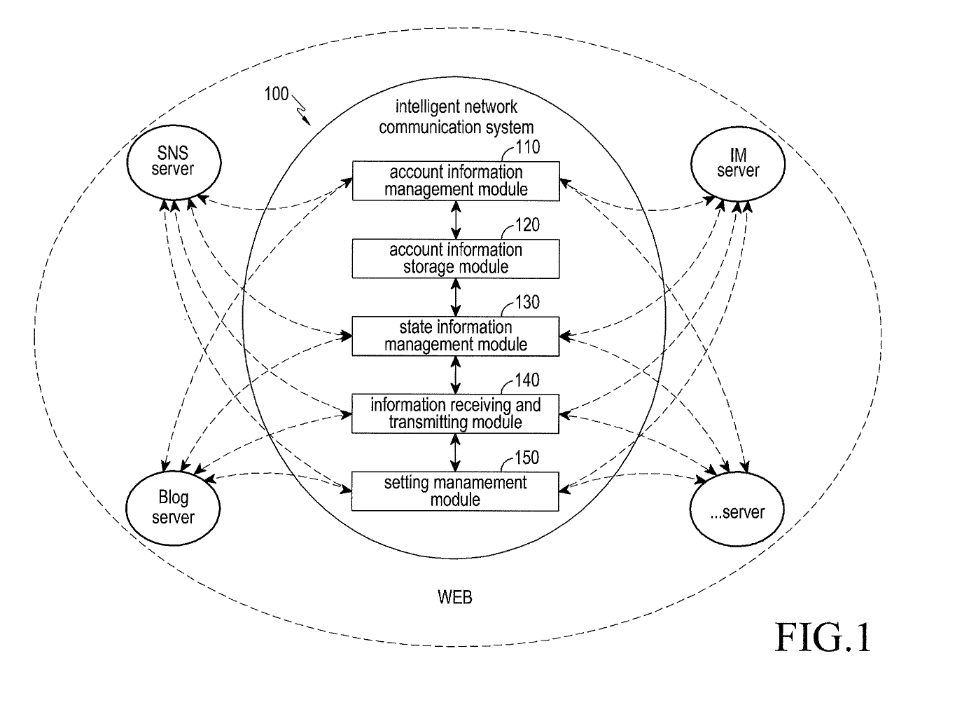

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communications network. Reference will now be made in detail to the embodiments of the present invention.

The terms “friend account” and “network account” mentioned hereinafter are all instant messaging accounts or network activity accounts registered by the user or friends. When the account registered by the friend is listed in the network account registered by the user, it also can be referred to as “friend account”.

FIG. 1 illustrates a configuration of a network communication system according to an exemplary embodiment of the present disclosure. As shown in FIG. 1, the network communication system 100 includes an account information management module 110, an account information storage module 120, a state information management module 130, an information receiving and transmitting module 140 and a setting management module 150.

The account information management module 110 provides an intelligent grouping and managing function for the friend accounts. After the user inputs his/her system account, the system automatically obtains all the friend accounts in the network accounts under the system account, analyzes the account information of all the friend accounts, extracts other network accounts included in the account information of the existing friend accounts, compares the extracted network account with the existing friend accounts to determine which ones belong to a particular friend, and adds said friend accounts belonging to said friend to the same account group. The undetermined friend account is grouped into an ungrouped account group, and is then manually grouped by the user and bound to the corresponding friends (contact person).

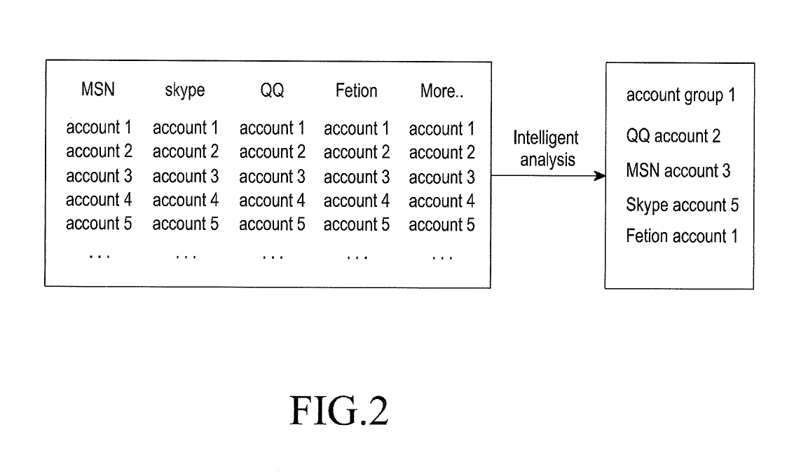

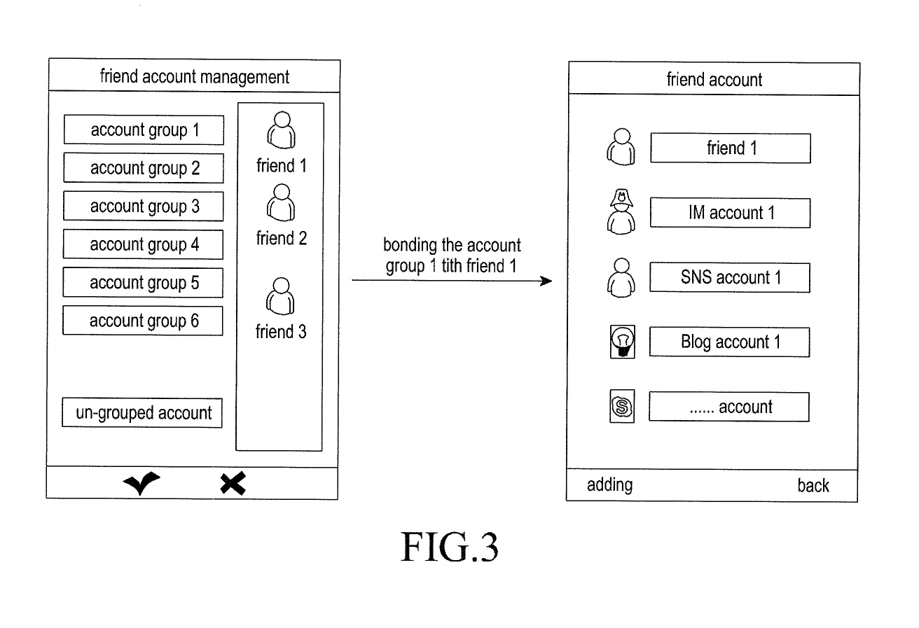

As shown in FIG. 2, it is assumed that the user registers a system account in the network communication system according to an exemplary embodiment of the present disclosure, and under said system account, the user logs in his MSN network account, Skype network account, QQ network account, Fetion network account, other network account and so on, each including a plurality of friend accounts. The account information management module 110 makes intelligent grouping for all the friend accounts under each network accounts owned by the user. For example, the account information management module 110 finds that the QQ account 2, MSN account 3, Skype account 5, Fetion account 1 which correlate with each other through an analysis, and determines that those accounts belong to one particular friend (contact person). Then, the account information management module 110 adds those accounts to the same account group (account group 1). Similarly, the account information management module 110 groups all the friend accounts based on the correlation between the friend accounts. The friend accounts having no correlation are added to ungrouped account group. Then, the user bonds the respective account groups to different friends. For example, as shown in FIG. 3, the user binds the account group 1 to the friend 1. That is, the IM account 1, SNS account 1 and Blog account 1 belong to one friend.

The account information storage module 120 stores all the obtained friend accounts and their account information into a storage device through a database or file system. Said friend accounts may include any network account for providing network service which can be obtained by the user, for example, an IM account, an SNS account, a Blog account, a web page bookmark, a web page game account, a network video account, a music online account and so on.

The state information management module 130 mainly performs the following three functions: a) obtaining all the friend accounts through inquiring the account information storage module 120 when the user logs in the network communication system according to an exemplary embodiment of the present disclosure; b) transmitting a request for inquiring the state of a friend to the network server (for example, SNS server, IM server, Blog server and so on), the network server responds to the request so as to ensure that the user can learn the state of the friend at any time; c) if the user transmits a message to one friend, the state information management module 130 selects the most suitable friend account as the message transmitting object according to the current state of the friend.

The information receiving and transmitting module 140 mainly performs two functions as follows: a) receiving the message from the network server under respective network accounts so as to update the network activity state of the friends; b) when transmitting message to a friend, inquiring the state information management module 130, selecting a most suitable friend account of the friend according to the online state and the activity trend of the friend.

If the user intends to make communication with the friends through the network communication system according to an exemplary embodiment of the present disclosure, the user first registers one system account in the network communication system, and sets a corresponding code. Then, the user logs in the network communication system by using the registered system account and code, registers his/her own network accounts for instant messaging (for example, MSN network account, IM network account, SNS network account, Skype network account, QQ network account, Fetion network account and so on), the network account in other social network and so on. If the user re-logs in the network communication system by using the registered system account, the network communication system will automatically log in the network accounts registered by the user.

Since the network communication system 100 has bond all the network account of a friend, a system verification may be performed through the setting management module 150 which provides a system account and code setting when the user logs in the network communication system so as to ensure the safety.

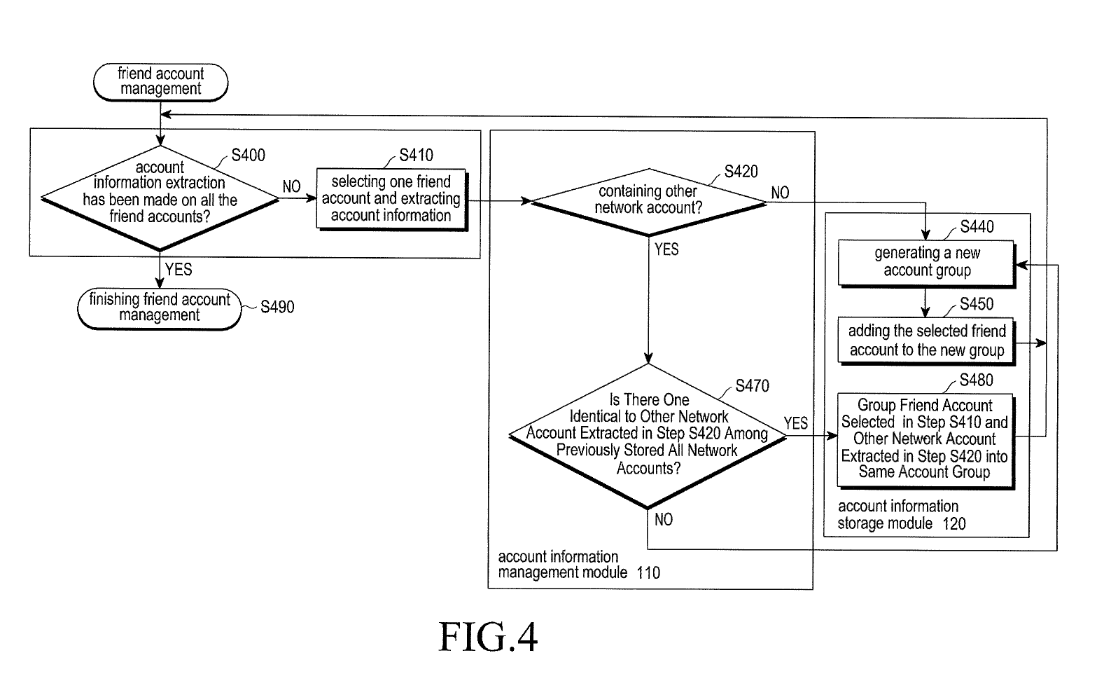

FIG. 4 illustrates a process of a friend accounts intelligent management in the network communication system according to an exemplary embodiment of the present disclosure. Hereinafter, the operation steps of method which is performed by the account information management module 110 will be described by referring to FIG. 4.

After the user logs in the network communication system according to the present disclosure by using his/her system account, and adds his/her network accounts, the information on all the friend accounts under his/her network accounts will be stored in the account information storage module 120. Then, the account information storage module 120 intelligently groups all the friend account.

As shown in FIG. 4, in step S400, it is determined whether the account information on the existing friend accounts under all the added network accounts of the user has been extracted. If there is friend accounts for which the account information is yet not extracted, in step S410, the account information management module 110 selects one friend account M (for example, the friend account M is an MSN network account) among the friend accounts for which the account information is yet not extracted, and extracts the account information of the friend account M from the server (for example, MSN server) which the friend account M belongs to through the information receiving and transmitting module 140. In step S420, it is determined whether the account information includes other network account. If the account information includes another network account N (for example, N is a QQ account), the network account N will be extracted and then the method proceeds to step S470.

In step S470, the extracted network account N is compared with all the existing network accounts stored in the account information storage module 120. As a result of comparison, if there is a network account identical to the extracted network account N, in step S480, the network account N extracted in step S420 and the friend account M selected in step S410 are grouped into the same account group. For example, if the network account identical to the extracted network account N is a network account K, it can be determined that the network account K is a QQ account (i.e., belong to the same friend). Thus, the network accounts M and K are added to the same account group in step S480, and as a result, the friend account M (i.e., the network account M), which is an MSN network, and the QQ account, which is identical to the extracted network account N as a result of comparison, are grouped into a single account group. Then, the method returns to step 400.

If the comparison result in step S470 is that there is no network account identical to the extracted network account N, the method proceeds to step S440 to generate a new account group and adds the selected friend account M to the new account group in step S450. Then, the method returns to step S400.

If the account information of the friend account M does not contain other network account in step S420, the method proceeds to step S440 to generate a new account group and add the friend account M to the new account group. Then, the method returns to perform step S400.

The above steps are repeated until the account information of all the friend accounts are extracted and compared. Accordingly, the friend account information management is finished (step S490). That is, the intelligent grouping for the friend accounts is finished.

After the intelligent grouping operation is performed by the account information management module 110, all the friend accounts are divided into several account groups. The friend accounts which do riot contain other network accounts and the friend accounts failed to compare are added to the un-grouped account group. The result of the intelligent grouping is shown in the left portion of FIG. 3. The friend accounts in the un-grouped account group can be further determined and grouped manually by the user.

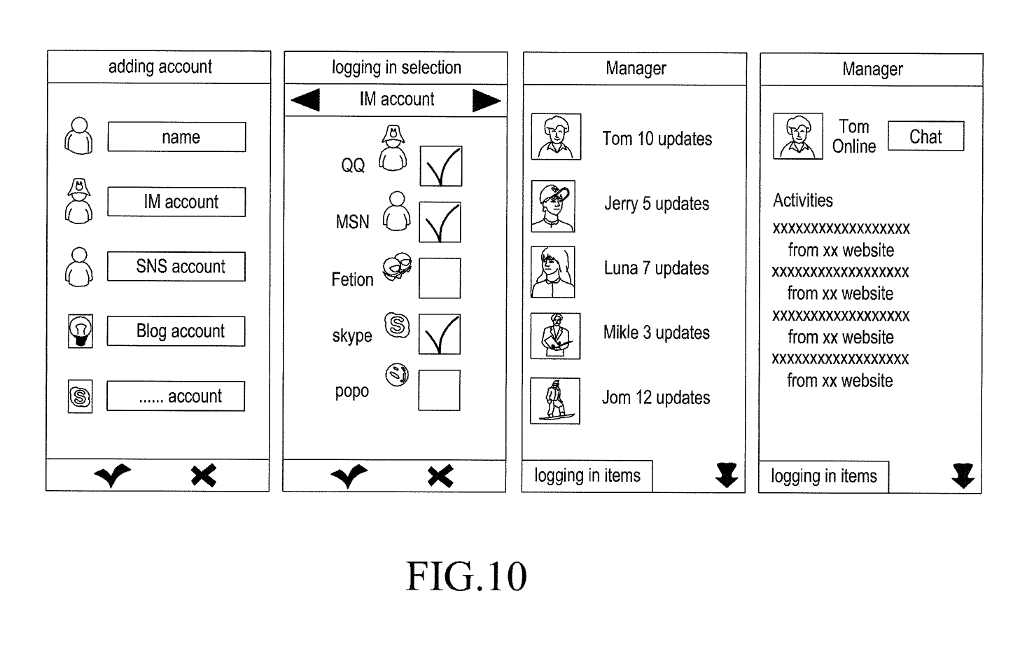

After the account information management module 110 finishes the intelligent grouping for the friend accounts, the user can bind respective account groups with corresponding friend. The right portion in FIG. 3 shows the state after the account group 1 is bond to the friend 1. When the user uses the network communication system for communication, the user may only see the icons and the online state of the friends in the displayed interface (as shown in the third column of FIG. 10), and cannot see how many network accounts the friend possesses. When the user sends messages to the corresponding friend, he/she is not required to select a certain network account of the friend, and only may need to click the icon of the friend.

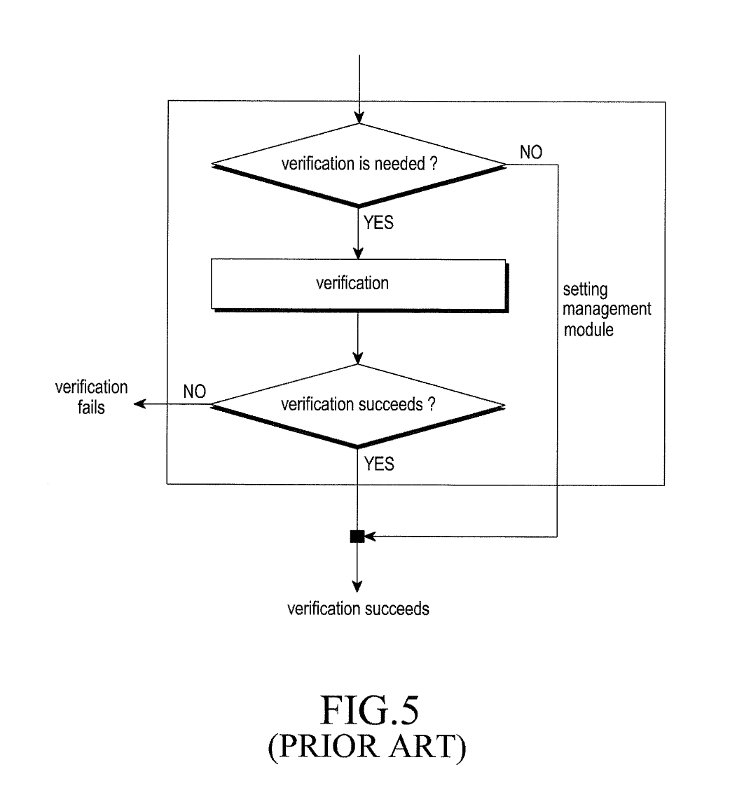

FIG. 5 illustrates a method performed by the setting management module 150 for verifying the system account. The user may set the operation for system account verification according to the requirement. When the user logs in the network communication system according to the present disclosure, the system verification is performed to ensure the safety when the user enters the system. Since the system verification can be achieved through the prior art, it will not be described in detail hereafter.

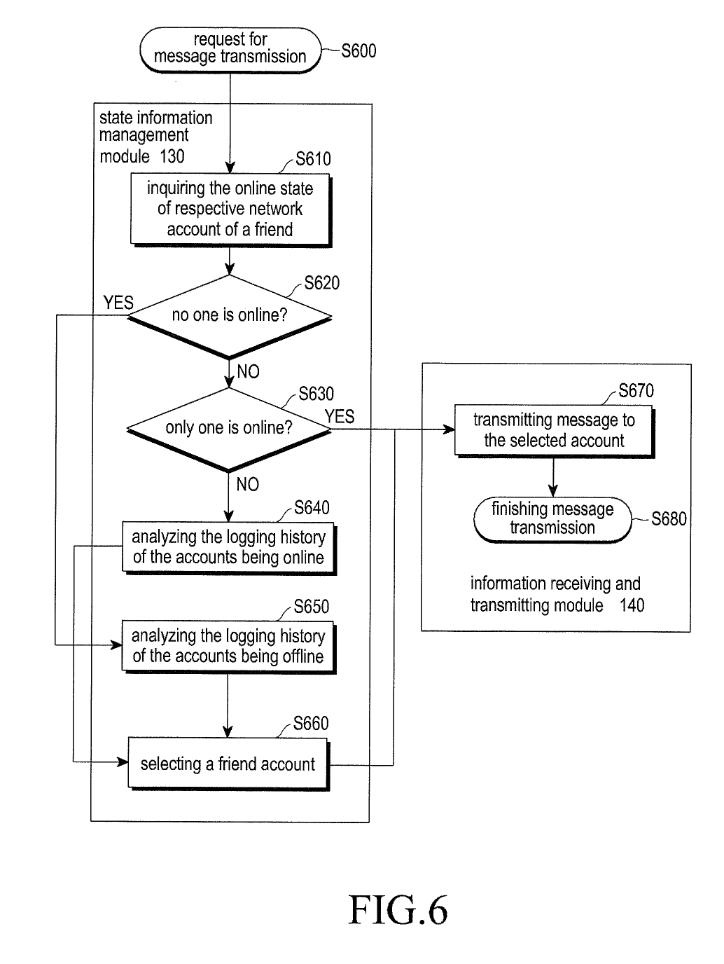

FIG. 6 illustrates a method for sending message in the network communication system according to an exemplary embodiment of the present disclosure. Hereinafter, the operations for sending message to the friend will be described by referring to FIG. 6.

When the user selects one friend among friend accounts divided into at least one account groups to request message transmission in step S600, the state information management module 130 inquires the states of respective network accounts belonging to the corresponding friend which are included in the system account of the user in step S610. In step S620, the online states of all the network accounts of the friend are determined. If none of the network accounts of the friend is online, the method proceeds to step S650. In step S650, the state information management module 130 analyzes the logging history record of the friend being offline. In step S660, one friend account commonly used by the friend is selected according to the logging history record analyzed in step S650, or the friend account commonly used by the friend to contact with the user is selected. Then in step S670, the information receiving and transmitting module 140 sends the message to the selected friend account. Then, the message sending is finished in step S680.

If it is determined that the friend has at least one network account being online in step S620, then it is determined whether the number of the network account being online is equal to 1 in step S630. If there is only one network account being online, the message is directly transmitted to the network account (steps S670 and S680).

If the determination result of step S630 is “NO”, it means that there is more than one network account of the friend are online (including free, busy and leaving states). Then, the state and logging history of the several network accounts are analyzed in step S640, that is, the logging in history of network accounts being online is analyzed, and one suitable network account is selected in step S660. For example, if only one network account being online is in a free state while the other accounts being online are in busy or leaving state, the message is directly sent to the network account being free. If several network accounts being online are in free state, their logging history records are analyzed and the network account being online which is commonly used is selected for message transmission. Similarly, all the network accounts being online are in busy or leaving state, the commonly used network account being online will be selected according to the logging history records (step S660). In step S670, the information receiving and transmitting module 140 sends the message to the selected friend account. Then, the message sending is finished in step S680.

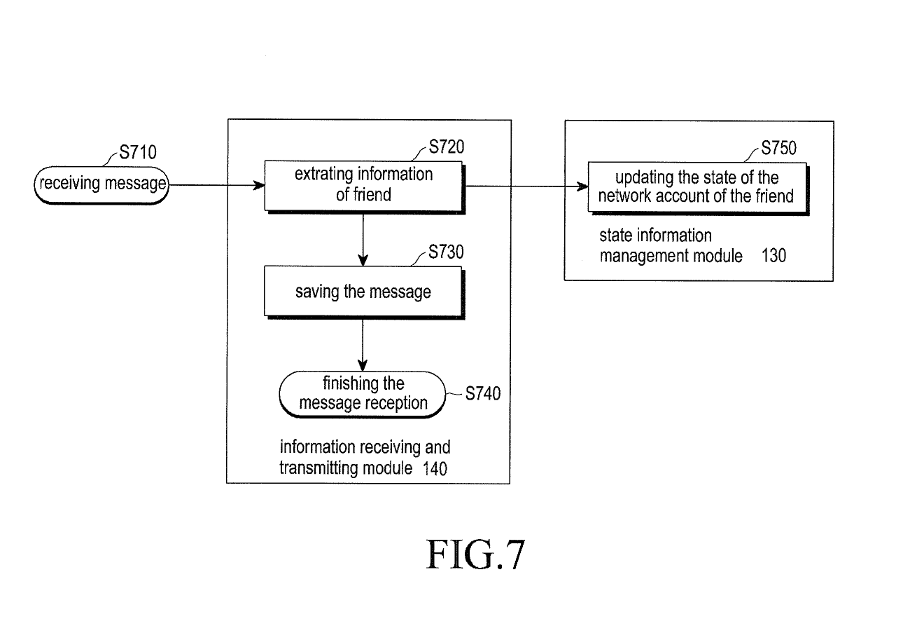

FIG. 7 illustrates a method for receiving the message reception in the network communication system according to an exemplary embodiment of the present disclosure. As shown in FIG. 7, when a message is received in step S710, the information receiving and transmitting module 140 extracts the account information of the friend account which sends the message (step S720) and determines which friend account sends the message and then the state information management module 130 updates the account state of the friend (step S750), including the logging history record and the network activity trend and so on. Meanwhile, the information receiving and transmitting module 140 stores the message (step S730). Accordingly, the message reception is achieved (step S740).

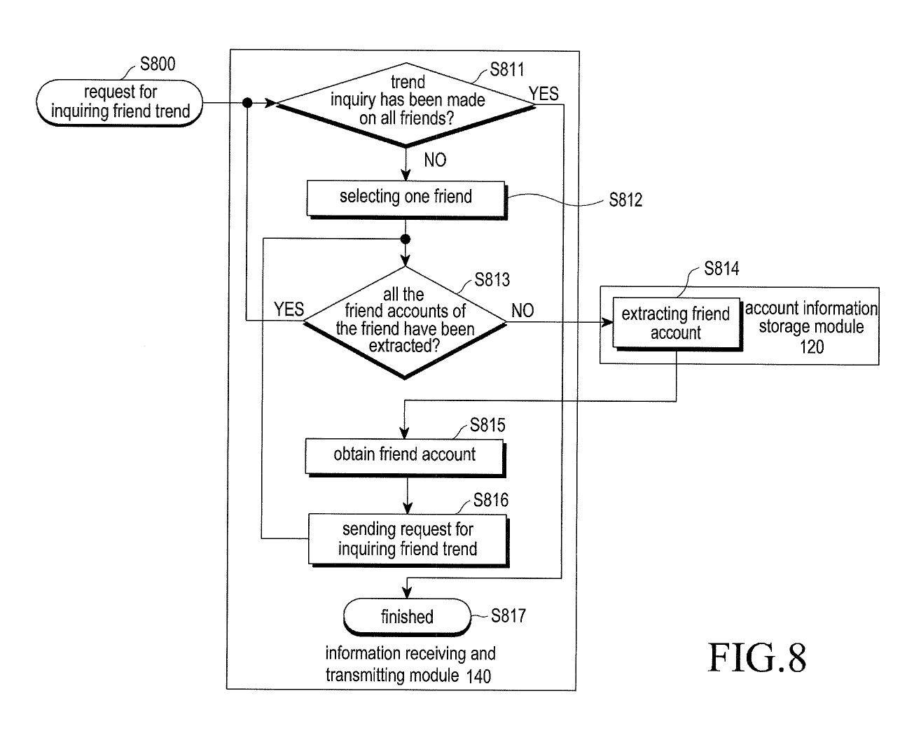

FIG. 8 illustrating a method for inquiring a friend information trend in the network communication system according to an exemplary embodiment of the present disclosure. The inquiry request is made by the state information management module 130 and the trend information obtained through the inquiry is stored in the state information management module 130.

As shown in FIG. 8, the information receiving and transmitting module 140 selects one friend, extracts the friend accounts of the friend, and sends an inquiry request to the network servers of the friend accounts so as to obtain the activity trend of the respective friend account of the friend. When the trend information inquiry is finished with respect to all the friends, the trend information inquiry is finished. According to the embodiment of the present disclosure, a safety verification can be performed after obtaining the network account of the friend. The operations for verification are illustrated in FIG. 5. If the verification is successful, the request for trend information inquiry is made through the information receiving and transmitting module 140. If the verification is failed, the trend information inquiry is made with respect to next friend account. The detailed description will be made by referring to FIG. 8.

First, the state information management module 130 makes a request for inquiring the activity trend of friend in step S800. In step S811, it is determined whether the activity trend inquiry has been made with respect to all the friends. If no, in step S812, one friend is selected among the friends whose activity trend have never been inquired. In step S813, it is determined how many network accounts the friend has and whether all the network accounts have been extracted for activity trend inquiry. If no, one network account of the friend is extracted from the account information storage module 120 in step S814. The information receiving and transmitting module 140 obtains the friend account from the account information storage module 120 in step S815 and makes an activity trend inquiry request to the server to which the selected network account belongs so as to update the activity trend of the selected network account in step S816. Then, the method returns to step S813 to extract next network account of the friend for activity trend inquiry until the activity trend inquiry has been made with respect to all the network accounts of the same friend.

If the activity trend inquiry is finished for all the network accounts of one certain friend (Yes in step S813), the method proceeds to step S811 to make the activity trend inquiry with respect to next friend.

In addition, before performing the step S816, the method may further include a verification step for verifying the safety of the activity trend inquiry. If the verification is succeeded, the state information management module 130 makes a request for inquiring the activity trend to the corresponding server through the information receiving and transmitting module 140. If the verification is failed, the method returns to step S813 to extract the next network account.

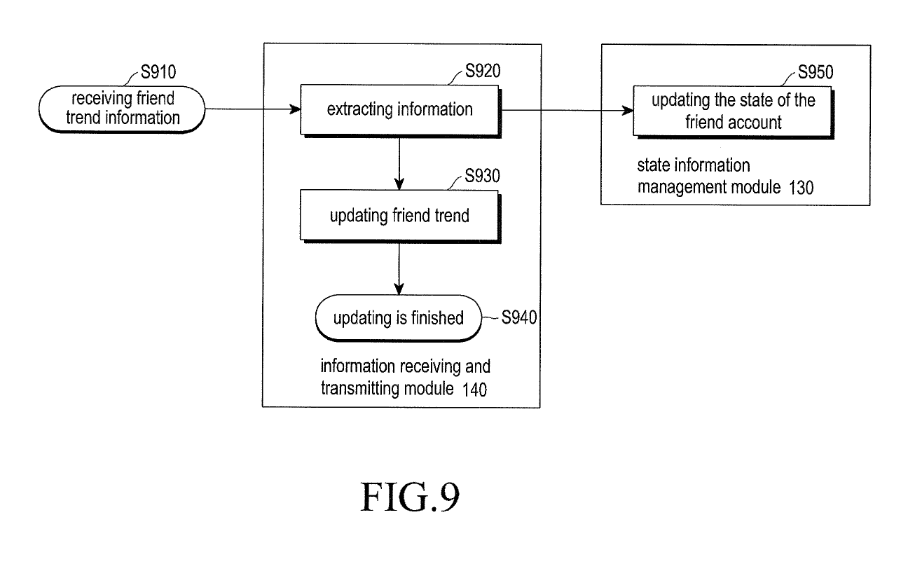

FIG. 9 illustrates a method for receiving the friend activity trend information. During the inquiring for the friend activity trend, the information receiving and transmitting module 140 receives the friend activity trend information from the network server to which the network account of the friend belongs (S910), extracts the information of the friend from the received friend activity trend information (S920), and updates the activity trends of the corresponding friend (S930 and S940). Meanwhile, the online state, the logging in history record and the network activity trend of the network account of the friend in the state information management module 130 are updated (S950).

According to the network communication system of the present disclosure, after the user logs in the system, the user can log in all the network accounts registered under the system account. Of course, the user can select some of network accounts registered under the system account to log in and the selected network accounts will automatically log in the network communication system. For example, the QQ account, MSN account and the Skype account are selected to log in as shown in FIG. 10. The interface displayed to the user is based on friend group regardless how many network accounts the friend has. For example, the interface displayed in FIG. 10 includes five friends, that is, Tom, Jerry, Luna, Mike and Jorn. The network accounts of the friends are not displayed and only the online states of the friends are displayed. When the user selects one friend for sending a message, the network communication system can automatically analyze all the network accounts of the friend, and select the most suitable network account as the address for receiving the message according to the online state and logging history record of the network accounts of the friend.

The network communication system according to the present disclosure includes the account information management module 110, the account information storage module 120, the state information management module 130, the information receiving and transmitting module 140 and the setting management module 150. The system may resolve multiple technical problems. However, the above modules are not necessarily included in the network communication system. For example, when the network communication system only includes an account information management module 110 and an account information storage module 120, the intelligent grouping of the friend accounts can be achieved. In this example, the state information management module 130 is not essential. In addition, those modules can be integrated into one module and also can be divided into more modules.

The network communication system according to the present disclosure, wherein, the network activity trends of the friends can be displayed to the user in real time such that the user can pay close attention to the activity trends of the friends. As shown in FIG. 10, it can be seen that Tom, Jerry, Luna, Mikle and Jorn have 10, 5, 7, 3 and 12 new network activities, respectively. When the user intends to learn the details of the updates of the network account of the friend, the user can see the detailed updates arranged in term of time, including the updates related to the SNS, Blog, pictures in forum, characters, video or music being listened by the friend, the games being played by the friend and so on.

In general, in comparison with the network communication manners in prior art, the network communication system and method according to the present disclosure provide at least the advantages as follows:

(1) As for the integrated instant messaging service in the prior art, the user still may need to log in each of the plurality of accounts or website although the user can learn the online state of the friends. However, according to the network communication system of the present disclosure, all the network accounts are bond together. As long as one of the network accounts of the friend is logged in, the network communication system can select the network account being online as the address for sending message such that an intelligent and effective communication manner is provided. Even if none of the network accounts of the friend is logged in currently, the network communication system can still select the network account commonly used by the friend to send an offline message.

(2) In comparison with the social network service (SNS) in which the users can only focus on the friends within the respective network, the network communication system according to the present disclosure integrates all the activity trends of the friends. As long as there are activities on the network, the network communication system according to the present disclosure can recognize and display the activity such that the user can learn all the activity trends information of the friend. Thus, the network communication system according to the present disclosure is more advantageous in usability in comparison with the conventional social network. In addition, the network communication system according to the present disclosure can analyze the information on the friends and correlate the relevant subjects from different friends with each other to generate hot spot information, thus the user can learn the content or news that interests all the friends only by checking the hot spot information.

(3) As for the existing FriendFeed, the user can view the network activity traces of other friend feed. However, the user can only track the trace and make communication within the friend feed circle. According to the network communication and method of the present disclosure, the tracking of the network activity trends of the friends and the communication among the friends are not limited to one certain network. The network communication system according to the present disclosure integrates all the tools for communication online and the network activities together. The network communication system can learn what tool for online communication is used by the friend so as to select a suitable instant message access to contact with the friend. As long as the user is logged on the network communication system of the present disclosure, he/she can use any network communication tools to communicate with the friend and learn the activities of the friend. Furthermore, the method provided by the present disclosure provides a convenient method for the user such that the user may conveniently learn the current network state of the friends and make contact with the friends.

(4) As for the forum, online games, online music, online video and so on, there is no approach for the user to learn those information instantly in one device according to the prior art. However, through the network communication system and method according to the present disclosure, the user can instantly view the traces of the friend and threads posted by the friend in any forums, and learn the music being listened by the friend and the places where the friend is playing games. Thus the information can be shared in a more convenient and efficient manner.

The system and method according to the present disclosure can integrate any network activity trend of the friends, including instant messaging information, socialized network friend trend, forum information and so on. In addition, according to the present disclosure, a user can instantaneously view the trace and threads made by the friends on any forums, and learn what music the friend is listening, where the friend is playing games and so on. According to the present disclosure, the communication and information sharing becomes more convenient and efficient.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A network communication system comprising:
an account information management module configured to store friend accounts of a user and account information of the friend accounts; and
an account information storage module configured to analyze the account information of the friend accounts, and determine whether to add a friend account of a friend to an account group including another friend account belonging to the friend based on network account information included in the account information.

2. The network communication system of claim 1 further comprising:
an information receiving and transmitting management module configured to transmit and receive messages to and from a network server associated with the friend account; and
a state information management module configured to manage network activity trend information of the friend account, send a request for activity trends of the friend to the network server, and receive a response to the request from the network server to obtain the network activity trend information of the friend.

3. The network communication system of claim 2 further comprising:
a setting management module configured to provide a system account and code setting, and add an instant message account of the user to an account of the user in the network communication system.

4. The network communication system of claim 1, wherein, the account information storage module is further configured to perform an automatic grouping for the friend accounts by:
selecting one friend account among the friend accounts listed in all network accounts of the user, and extracting the account information of the selected friend account;
if the account information of the selected friend account includes another network account, extracting the other network account;
comparing the other network account with the account information of the one friend stored in the account information storage module, to determine whether there is a network account identical to the other network account; and
if there is the network account identical to the other network account, adding the selected friend account and the network account identical to the other network account to the account group.

5. The network communication system of claim 4, wherein, if there is no other network account included in the account information of the one friend account or if there is no network account identical to the other network account, the selected friend account is added to a new account group.

6. The network communication system of claim 2, wherein, the state information management module is further configured to periodically transmit a trend inquiry request to servers of respective friend accounts, and update the network activity trend information of the friend accounts.

7. The network communication system of claim 2, wherein, the state information management module is further configured to update and online state and logging in history of the friend account according to information received by the information receiving and transmitting management module.

8. The network communication system of claim 2, wherein when one friend is selected by the user for message transmission, the information receiving and transmitting management module is further configured to select, when no accounts of the one friend are online, one friend account of the one friend to send an offline message to through analyzing a logging in history with respect to respective friend accounts of the one friend.

9. The network communication system of claim 2, wherein when one friend is selected by the user for message transmission, the information receiving and transmitting management module is further configured to send, when only one friend account is online with respect the one friend, a message directly to the only one friend account being online.

10. The network communication system of claim 2, wherein when one friend is selected by the user for message transmission, the information receiving and transmitting management module is further configured to select, when two or more friend accounts are online with respect to the one friend, a friend account commonly used by the one friend for the message transmission based on an online state and the logging in history.

11. A method for network communication, the method comprising:
registering a system account of a user in a network communication system;
logging in the network communication system through the registered system account, and registering instant messaging accounts of the system account of the user, wherein the network communication system automatically adds all friend accounts of the instant messaging accounts; and
grouping all the friend accounts according to account information of the friend accounts.

12. The method of claim 11, wherein grouping all the friend accounts according to the account information of the friend accounts comprises:
selecting one friend account and extracting the account information of the one friend account;
determining whether the extracted account information includes another network account;
if the other network account is included in the extracted account information, comparing the other network account with each of all the friend accounts of each instant messaging account;
if there is a network account identical to the other network account, grouping the one friend account and the identical network account into a same account group;
if there is no network account identical to the other network account or if the account information does not include another network account, adding the one friend account to a new account group.

13. The method of claim 11 further comprising:
updating friend trend information by:
periodically transmitting a trend inquiry request to servers of respective friend accounts; and
updating a network activity trend and a logging in history of the respective friend accounts according to a received result of the trend inquiry request.

14. The method of claim 13, further comprising:
when message transmission to a certain friend is requested by the user, selecting one friend account associated with the certain friend for message transmission according to an online state and logging in history of the friend accounts of the friend.

15. The method of claim 14, wherein the message transmission comprises transmitting the message using a scheme selected from a group of schemes including:
a first scheme, wherein when none of the friend accounts of the certain friend are online, an offline message is sent to a friend account most commonly used by the certain friend through analyzing the logging in history with respect to the friend accounts of the certain friend;
a second scheme, wherein when only one friend account is online with respect the certain friend, an information receiving and transmitting management module sends a message directly to the only one friend account being online; and
a third scheme, wherein when two or more friend accounts are online with respect to the certain friend, the information receiving and transmitting management module selects a friend account commonly used by the certain friend for message transmission according to the online state and the logging in history and transmits the message.

16. The method of claim 13, wherein, updating the friend trend information further comprises:
selecting one friend;
selecting one network accounts of the one friend;
sending a request for trend information to a server associated with the one network account; and
receiving the trend information, and updating the network activity trend of the one network account.

17. The method of claim 16, wherein, updating the friend trend information further comprises:
determining whether a trend inquiry has been made with respect to all network accounts owned by the one friend;
if the trend inquiry has been made for all the network accounts owned by the one friend, selecting a next friend to update the friend trend information.

18. The method of claim 17, wherein, updating the friend trend information further comprises:
if the trend inquiry has not been made for all the network accounts owned by the one friend, selecting a next network account of the one friend to update the friend trend information.

19. The method of claim 14, wherein the message transmission comprises:
when none of the friend accounts of the certain friend are online, sending an offline message to a friend account most commonly used by the certain friend through analyzing the logging in history with respect to the friend accounts of the certain friend;
when only one friend account is online with respect the certain friend, sending a message directly to the only one friend account being online; and
when two or more friend accounts are online with respect to the certain friend, selecting a friend account commonly used by the certain friend for message transmission according to the online state and the logging in history, and transmitting the message.
